(19) United States
(12) Patent Application Publication
(10) Pub. No.: US 2021/0276521 A1
(43) Pub. Date: Sep. 9, 2021

(54) VEHICLE CONTROL APPARATUS

(71) Applicant: Toyota Jidosha Kabushiki Kaisha, Toyota-shi Aichi-ken (JP)

(72) Inventors: Junya Ota, Susono-shi (JP); Hiroshi Isono, Mishima-shi (JP)

(73) Assignee: Toyota Jidosha Kabushiki Kaisha, Toyota-shi Aichi-ken (JP)

(21) Appl. No.: 17/190,893

(22) Filed: Mar. 3, 2021

(30) Foreign Application Priority Data
Mar. 9, 2020 (JP) 2020-039755

(51) Int. Cl. B60T 8/58; B60T 8/17

(52) U.S. Cl. CPC B60T 8/58; B60T 8/17; B60T 2250/04; B60T 2201/02; B60T 2240/00

(57) ABSTRACT

A vehicle control apparatus executes a wheel speed change control to control speeds of first road wheels and a second road wheel to a lower limit wheel speed or more when braking forces are applied to the first and second road wheels, and at least one of the speeds of the first and second road wheels becomes lower than the lower limit wheel speed. A vehicle speed change control executes a first increase-decrease control which alternately executes a first increase control to increase braking forces applied to the first road wheels together and a first decrease control to decrease the braking forces applied to the first road wheels together and (ii) a second increase-decrease control which increases and decreases the braking force applied to the second road wheel.

### CROSS-REFERENCE TO RELATED APPLICATIONS

This application claims priority to Japanese patent application No. JP 2020-039755 filed on Mar. 9, 2020, the content of which is hereby incorporated by reference in its entirety.

### BACKGROUND

### Field

The present disclosure relates to a vehicle control apparatus.

### Description of the Related Art

A friction coefficient of a road wheel of a vehicle to a road surface becomes largest when a slip ratio of the road wheel is a certain slip ratio. Hereinafter, the certain slip ratio will be referred to as “the optimum slip ratio.” Therefore, in order to achieve a short braking distance of the vehicle when braking forces are applied to the road wheels to brake the vehicle, the braking forces should be controlled and applied to the road wheels with preventing the slip ratios of the road wheels from exceeding the optimum slip ratio.

In this regard, there is known a vehicle control apparatus which executes a braking force control to control the braking forces applied to the road wheels of the vehicle to brake the vehicle with preventing the slip ratios of the road wheels from significantly exceeding the optimum slip ratio (for example, see JP 2007-62520 A). In this known vehicle control apparatus, a threshold of the slip ratio is set to prevent the slip ratios of the road wheels from significantly exceeding the optimum slip ratio. The known vehicle control apparatus prevents the slip ratios of the road wheels from significantly exceeding the optimum slip ratio by alternately increasing and decreasing the braking forces applied to the road wheels when the slip ratios of the road wheels exceeds the threshold.

If the braking forces applied to the road wheels are separately increased and decreased when the slip ratios of the road wheels become larger than the threshold, all of speeds of the road wheels may simultaneously decrease to a larger extent than a decrease of an actual vehicle body moving speed (i.e., a moving speed of a body of the vehicle relative to the road surface).

In general, the slip ratios of the road wheels are calculated, based on the vehicle body moving speed. The vehicle body moving speed is calculated, based on wheel speeds (i.e., the speeds of the road wheels relative to the road surface). Therefore, if all of the wheel speeds simultaneously decrease to the larger extent than the decrease of the actual vehicle body moving speed, the exact vehicle body moving speed cannot be calculated. If the exact vehicle body moving speed cannot be calculated, the exact slip ratios cannot be calculated. As a result, the braking forces applied to the road wheels cannot be properly controlled to prevent the slip ratios of the road wheels from significantly exceeding the optimum slip ratio. In this case, the braking distance of the vehicle may increase. Therefore, in order to achieve the short braking distance of the vehicle, all of the road wheels should be prevented from simultaneously decreasing to the larger extent than the decrease of the actual vehicle body moving speed.

### SUMMARY

The present disclosure has been made for solving the problems described above. An object of the present disclosure is to provide a vehicle control apparatus which can prevent all of the wheel speeds from simultaneously decreasing to the larger extent than the decrease of the actual vehicle body moving speed while a control to increase and decrease the braking forces applied to the road wheels, is executed.

A vehicle control apparatus according to the present disclosure is applied to a vehicle including at least two first road wheels and at least one second road wheel.

The vehicle control apparatus comprises a braking apparatus which individually applies braking forces to the at least two first road wheels and the at least one second road wheel, and an electronic control unit which controls (i) first braking forces corresponding to the braking forces applied to the at least two first road wheels from the braking apparatus and (ii) a second braking force corresponding to the braking force applied to the at least one second road wheel from the braking apparatus.

The electronic control unit is configured to set a lower limit wheel speed, based on at least one of speeds of the at least two first road wheels and the at least one second road wheel, which produces a maximum friction coefficient between (i) each of the at least two first road wheels and the at least one second road wheel and (ii) a surface of a road which the at least two first road wheels and the at least one second road wheel contact.

The electronic control unit is further configured to execute a wheel speed change control to control the speeds of the at least two first road wheels and the at least one second road wheel to values equal to or larger than the lower limit wheel speed when (i) the electronic control unit applies the braking forces to the at least two first road wheels and the at least one second road wheel, and (ii) at least one of the speeds of the at least two first road wheels and the at least one second road wheel becomes lower than the lower limit wheel speed.

The electronic control unit is further configured to execute a vehicle speed change control to execute (i) a first increase-decrease control which alternately executes a first increase control to increase the first braking forces together and a first decrease control to decrease the first braking forces together and (ii) a second increase-decrease control which increases and decreases the second braking force.

As described above, if the braking forces applied to the road wheels are separately increased and decreased, all of the speeds of the road wheels may simultaneously decrease to the larger extent than the decrease of the actual vehicle body moving speed.

With the vehicle control apparatus according to the present disclosure, the first braking forces are increased together and decreased together while the vehicle speed change control is executed. Therefore, when one of the first braking forces is increased, the other first braking force is also increased. Moreover, when one of the first braking forces is decreased, the other first braking force is also decreased. Therefore, the first braking forces are not separately increased nor decreased. Thus, a possibility in the present disclosure that the speeds of the first road wheels simultaneously decrease to the larger extent than the decrease of the actual vehicle body moving speed, is small, compared to when the first braking forces are separately increased and decreased. Therefore, all of the speeds of the road wheels can be prevented from simultaneously decreasing to the larger extent than the decrease of the actual vehicle body moving speed.

According to a teaching of the present disclosure, the at least one second road wheel may include road wheels. In this teaching, the second increase-decrease control may be a control to alternately execute a second increase control to increase the second braking forces together and a second decrease control to decrease the second braking forces together.

With this teaching of the present disclosure, the second braking forces are increased together and decreased together while the vehicle speed change control is executed. Therefore, the second braking forces are not separately increased nor decreased. Therefore, a possibility in this teaching of the present disclosure that the speeds of the second road wheels simultaneously decrease to the larger extent than the decrease of the actual vehicle body moving speed, is small, compared to when the second braking forces are separately increased and decreased. Thus, all of the speeds of the road wheels can be prevented from simultaneously decreasing to the larger extent than the decrease of the actual vehicle body moving speed.

A vehicle control apparatus according to the present disclosure is applied to a vehicle including at least two first road wheels and at least one second road wheel.

The vehicle control apparatus comprises a braking apparatus which individually applies braking forces to the at least two first road wheels and the at least one second road wheel, and an electronic control unit which controls (i) first braking forces corresponding to the braking forces applied to the at least two first road wheels from the braking apparatus and (ii) a second braking force corresponding to the braking force applied to the at least one second road wheel from the braking apparatus.

The electronic control unit is configured to set a lower limit wheel speed, based on at least one of speeds of the at least two first road wheels and the at least one second road wheel, which produces a maximum friction coefficient between (i) each of the at least two first road wheels and the at least one second road wheel and (ii) a surface of a road which the at least two first road wheels and the at least one second road wheel contact.

The electronic control unit is further configured to execute a wheel speed change control to control the speeds of the at least two first road wheels and the at least one second road wheel to values equal to or larger than the lower limit wheel speed when (i) the electronic control unit applies the braking forces to the at least two first road wheels and the at least one second road wheel, and (ii) at least one of the speeds of the at least two first road wheels and the at least one second road wheel becomes lower than the lower limit wheel speed.

The electronic control unit is further configured to execute a vehicle speed change control to (i) decrease the second braking force during a first period while at least one of the first braking forces is increased and (ii) decrease at least one of the first braking forces during a second period while the second braking force is increased.

As described above, in order to achieve the short braking distance of the vehicle, all of the speeds of the road wheels should be prevented from decreasing to the larger extent than the actual vehicle body moving speed.

With the vehicle control apparatus according to the present disclosure, the first braking force is decreased while the second braking force is increased. Therefore, even when the speed of the first road wheel decreases, a possibility that the speed of the second road wheel decreases, is extremely low. Similarly, with the vehicle control apparatus according to the present disclosure, the second braking force is decreased while the first braking force is increased. Therefore, even when the speed of the second road wheel decreases, a possibility that the speed of the first road wheel decreases, is extremely low. Thus, all of the speeds of the road wheels can be prevented from simultaneously decreasing to the larger extent than the decrease of the actual vehicle body moving speed.

According to a teaching of the present disclosure, the vehicle speed change control may be a control to execute (i) a first increase-decrease control which alternately executes a first increase control to increase the at least one first braking force and a first decrease control to decrease the at least one first braking force and (ii) a second increase-decrease control which alternately executes a second increase control to increase the second braking force and a second decrease control to decrease the second braking force.

According to a teaching of the present disclosure, the vehicle speed change control may be a control to execute a first increase control to increase the at least one first braking force, a first decrease control to decrease the at least one first braking force, a second increase control to increase the second braking force, and a second decrease control to decrease the second braking force.

A vehicle control apparatus according to the present disclosure is applied to a vehicle including at least one front road wheel and at least one rear road wheel.

The vehicle control apparatus comprises a braking apparatus which individually applies braking forces to the at least one front road wheel and the at least one rear road wheel, and an electronic control unit which controls (i) a front road wheel braking force corresponding to the braking force applied to the at least one front road wheel from the braking apparatus and (ii) a rear road wheel braking force corresponding to the braking force applied to the at least one rear road wheel from the braking apparatus.

The electronic control unit is configured to set a lower limit wheel speed, based on at least one of speeds of the at least one front road wheel and the at least one rear road wheel, which produces a maximum friction coefficient between (i) each of the at least one front road wheel and the at least one rear road wheel and (ii) a surface of a road which the at least one front road wheel and the at least one rear road wheel contact.

The electronic control unit is further configured to execute a wheel speed change control to control the speeds of the at least one front road wheel and the at least one rear road wheel to values equal to or larger than the lower limit wheel speed when (i) the electronic control unit applies the braking forces to the at least one front road wheel and the at least one rear road wheel, and (ii) at least one of the speeds of the at least one front road wheel and the at least one rear road wheel becomes lower than the lower limit wheel speed.

The wheel speed change control is a control to execute a first decrease control to decrease the front road wheel braking force when (i) the braking forces are applied to the at least one front road wheel and the at least one rear road wheel, and (ii) the speed of the at least one front road wheel becomes lower than the lower limit wheel speed, execute a first increase control to increase the front road wheel braking force when the speed of the at least one front road wheel becomes equal to or higher than a regaining determination threshold higher than the lower limit wheel speed while the first decrease control is executed, execute a second decrease control to decrease the rear road wheel braking force when (i) the braking forces are applied to the at least one front road wheel and the at least one rear road wheel, and (ii) the speed of the at least one rear road wheel becomes lower than the lower limit wheel speed, and execute a second increase control to increase the rear road wheel braking force when the speed of the at least one rear road wheel becomes equal to or higher than the regaining determination threshold while the second decrease control is executed.

With the vehicle control apparatus according to the present disclosure, in general, the front road wheel braking force is decreased while the rear road wheel braking force is increased. Moreover, the front road wheel braking force is increased while the rear road wheel braking force is decreased. Thereby, a vehicle load transfers from a front portion of the vehicle to a rear portion of the vehicle and vice versa. Thereby, (i) a point of time when the speed of the front road wheel reaches the lower limit wheel speed and (ii) a point of time when the speed of the rear road wheel reaches the lower limit wheel speed, may be different. Also, (i) a point of time when the speed of the front road wheel reaches the regaining determination threshold and (ii) a point of time when the speed of the rear road wheel reaches the regaining determination threshold, may be different. Thereby, all of the speeds of the road wheels do not simultaneously decrease to the larger extent than the actual vehicle body moving speed. Thus, all of the speeds of the road wheels can be prevented from simultaneously decreasing to the larger extent than the actual vehicle body moving speed.

According to a teaching of the present disclosure, the vehicle may include a front left road wheel, a front right road wheel, a rear left road wheel, and a rear right road wheel. In this teaching, the at least two first road wheels may include the front left road wheel and the front right road wheel. Moreover, the at least one second road wheel may include the rear left road wheel and the rear right road wheel.

According to a teaching of the present disclosure, the vehicle may include a front left road wheel, a front right road wheel, a rear left road wheel, and a rear right road wheel. In this teaching, the at least two first road wheels may include the front left road wheel and the rear left road wheel. Moreover, the at least one second road wheel may include the front right road wheel and the rear right road wheel.

According to a teaching of the present disclosure, the electronic control unit may be configured to stop executing the wheel speed change control when the speeds of the at least two first road wheel and the at least one second road wheel become equal to or higher than the lower limit wheel speed while the electronic control unit executes the wheel speed change control.

According to a teaching of the present disclosure, the electronic control unit may be configured to stop executing the wheel speed change control when the speeds of the at least two first road wheel and the at least one second road wheel continue being equal to or higher than the lower limit wheel speed for a predetermined amount of time while the electronic control unit executes the wheel speed change control.

According to a teaching of the present disclosure, the electronic control unit may be configured to stop executing the wheel speed change control when the speeds of the first road wheels become equal to or higher than a regaining determination threshold higher than the lower limit wheel speed while the electronic control unit executes the first decrease control. Moreover, the electronic control unit may be configured to stop executing the wheel speed change control when the speed of the at least one second road wheel becomes equal to or higher than the regaining determination threshold while the electronic control unit increases the second braking force.

According to a teaching of the present disclosure, the electronic control unit may be configured to stop executing the wheel speed change control when the speeds of the at least two first road wheels continue being equal to or higher than a regaining determination threshold higher than the lower limit wheel speed for a predetermined first amount of time while the electronic control unit executes the first decrease control. Moreover, the electronic control unit may be configured to stop executing the wheel speed change control when the speed of the at least one second road wheel continues being equal to or higher than the regaining determination threshold for a predetermined second amount of time while the electronic control unit increases the second braking force.

According to a teaching of the present disclosure, the lower limit wheel speed may be the at least one of the speeds of the at least two first road wheels and the at least one second road wheel, which (i) produces the maximum friction coefficient between each of the at least two first road wheels and the at least one second road wheel and the surface of the road and (ii) causes a friction coefficient between each of the at least two first road wheels and the at least one second road wheel and the surface of the road to be a lower limit value of an acceptable range.

According to a teaching of the present disclosure, the electronic control unit may be configured to set the lower limit wheel speed, based on a moving speed of a body of the vehicle acquired, based on at least one of the speeds of the at least two first road wheels and the at least one second road wheel.

Elements of the present disclosure are not limited to elements of embodiments and modified examples of the present disclosure described along with the drawings. The other objects, features and accompanied advantages of the present disclosure can be easily understood from the embodiments and the modified examples of the present disclosure.

### BRIEF DESCRIPTION OF THE DRAWINGS

FIG. 1 is a view showing a vehicle control apparatus according to an embodiment of the present disclosure and a vehicle which the vehicle control apparatus is applied to.

FIG. 2 is a view showing the vehicle which the vehicle control apparatus according to the embodiment of the present disclosure is applied to.

FIG. 3A is a view showing changes of front wheel braking forces while a first increase-decrease control is executed.

FIG. 3B is a view showing changes of rear wheel braking forces while a second increase-decrease control is executed.

FIG. 4 is a view showing changes of wheel speeds and braking forces while an ordinary braking control and a wheel speed regaining control are executed.

FIG. 5 is a view showing a routine executed by the vehicle control apparatus according to the embodiment of the present disclosure.

FIG. 6 is a view showing a routine executed by the vehicle control apparatus according to the embodiment of the present disclosure.

FIG. 7 is a view showing a routine executed by the vehicle control apparatus according to the embodiment of the present disclosure.

FIG. 8 is a view showing the changes of the wheel speeds and the braking forces while the ordinary braking control and the wheel speed regaining control according to a first modified example of the embodiment of the present disclosure are executed.

FIG. 9 is a view showing a routine executed by the vehicle control apparatus according to the first modified example of the embodiment of the present disclosure.

FIG. 10 is a view showing a routine executed by the vehicle control apparatus according to the first modified example of the embodiment of the present disclosure.

FIG. 11 is a view showing the changes of the wheel speeds, the braking forces, and vehicle loads while the ordinary braking control and the wheel speed regaining control according to a second modified example of the embodiment of the present disclosure are executed.

### DESCRIPTION OF THE EMBODIMENTS

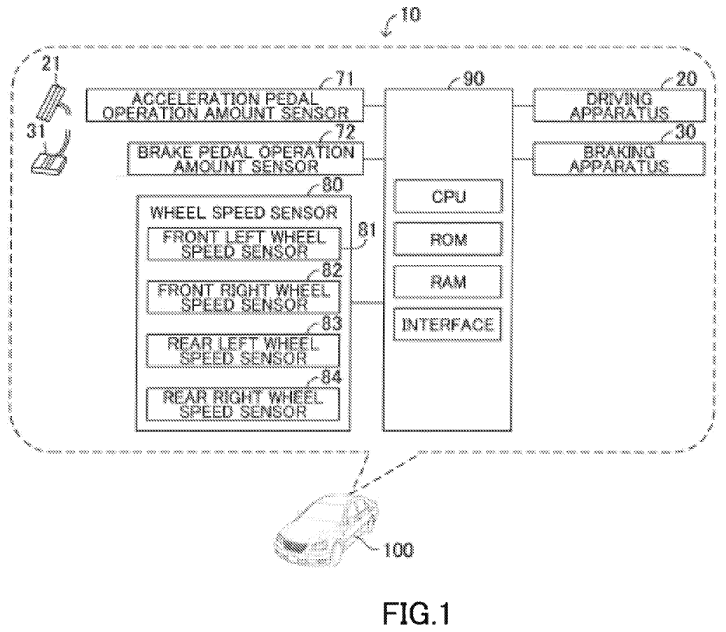

Below, a vehicle control apparatus 10 according to an embodiment of the present disclosure will be described with reference to the drawings. As shown in FIG. 1, the vehicle control apparatus 10 is installed on a vehicle 100.

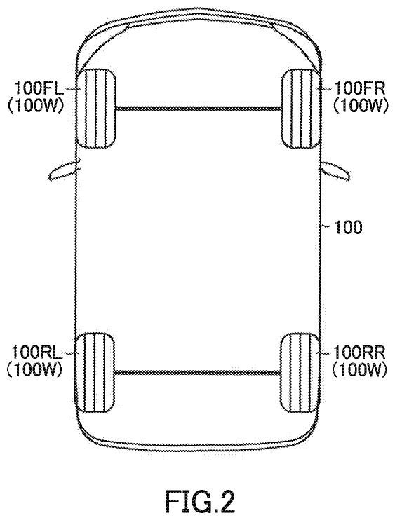

As shown in FIG. 2, the vehicle 100 includes four road wheels, i.e., a front left wheel 100FL, a front right wheel 100FR, a rear left wheel 100RL, and a rear right wheel 100RR. In this embodiment, the front left wheel 100FL and the front right wheel 100FR are steered wheels as well as driven wheels. In this description, the front left wheel 100FL and the front right wheel 100FR will be collectively referred to as “the front wheels 100F.” Also, the rear left wheel 100RL and the rear right wheel 100RR will be collectively referred to as “the rear wheels 100R.” Also, the front left wheel 100FL, the front right wheel 100FR, the rear left wheel 100RL, and the rear right wheel 100RR will be collectively referred to as “the road wheels 100W.”

As shown in FIG. 1, the vehicle 100 is installed with a driving apparatus 20 and a braking apparatus 30.

The driving apparatus 20 generates a torque TQdriver to be applied to the driven wheels of the vehicle 100 (i.e., the front left wheel 100FL and the front right wheel 100FR) to move the vehicle 100. In this embodiment, the driving apparatus 20 includes at least one electric motor. However, the driving apparatus 20 may include an internal combustion engine. Alternatively, the driving apparatus 20 may include the at least one electric motor and the internal combustion engine. Hereinafter, the torque TQdriver applied to the driven wheels of the vehicle 100 from the driving apparatus 20, will be referred to as “the driving torque TQdriver.”

The braking apparatus 30 generates a braking torque TQbrake to be applied to the road wheels 100W (i.e., the front left wheel 100FL, the front right wheel 100FR, the rear left wheel 100RL, and the rear right wheel 100RR) to brake the vehicle 100.

In this description, a front left wheel braking force BFL is a braking force B applied to the front left wheel 100FL. Similarly, a front right wheel braking force BFR is the braking force B applied to the front right wheel 100FR. Similarly, a rear left wheel braking force BRL is the braking force B applied to the rear left wheel 100RL. Similarly, a rear right wheel braking force BRR is the braking force B applied to the rear right wheel 100RR.

Moreover, in this description, front wheel braking forces BF are the front left wheel braking force BFL and the front right wheel braking force BFR. Similarly, rear wheel braking forces BR are the rear left wheel braking force BRL and the rear right wheel braking force BRR. Further, the braking forces B are the front left wheel braking force BFL, the front right wheel braking force BFR, the rear left wheel braking force BRL, and the rear right wheel braking force BRR. Therefore, each of the braking forces B is each of the front left wheel braking force BFL, the front right wheel braking force BFR, the rear left wheel braking force BRL, and the rear right wheel braking force BRR.

The vehicle control apparatus 10 includes an ECU 90. The ECU 90 includes a CPU, a ROM, a RAM, and an interface.

The driving apparatus 20 and the braking apparatus 30 are electrically connected to the ECU 90. The ECU 90 can control the driving torque TQdriver generated by the driving apparatus 20 by controlling activations of the driving apparatus 20. In addition, the ECU 90 can control the braking torque TQbrake generated by the braking apparatus 30 by controlling activations of the braking apparatus 30.

The braking force applied to the front left wheel 100FL by the braking torque TQbrake applied to the front left wheel 100FL, is the front left wheel braking force BFL. Similarly, the braking force applied to the front right wheel 100FR by the braking torque TQbrake applied to the front right wheel 100FR, is the front right wheel braking force BFR. Similarly, the braking force applied to the rear left wheel 100RL by the braking torque TQbtrake applied to the rear left wheel 100RL, is the rear left wheel braking force BRL. Similarly, the braking force applied to the rear right wheel 100RR by the braking torque TQbtrake applied to the rear right wheel 100RR, is the rear right wheel braking force BRR. As described above, the front left wheel braking force BFL and the front right wheel braking force BFR will be collectively referred to as “the front wheel braking forces BF.” Similarly, the rear left wheel braking force BRL and the rear right wheel braking force BRR will be collectively referred to as “the rear wheel braking forces BR.” Further, the front left wheel braking force BFL, the front right wheel braking force BFR, the rear left wheel braking force BRL, and the rear right wheel braking force BRR will be collectively referred to as “the braking forces B.”

Further, the vehicle 100 is installed with an acceleration pedal operation amount sensor 71, a brake pedal operation amount sensor 72, and a wheel speed sensor 80. The acceleration pedal operation amount sensor 71, the brake pedal operation amount sensor 72, and the wheel speed sensor 80 are electrically connected to the ECU 90.

The acceleration pedal operation amount sensor 71 detects an amount of an operation applied to an acceleration pedal 21 of the vehicle 100 and sends a signal representing the detected amount of the operation to the ECU 90. The ECU 90 acquires the amount of the operation applied to the acceleration pedal 21 as an acceleration pedal operation amount AP, based on the received signal. The ECU 90 controls the activations of the driving apparatus 20, based on the acquired acceleration pedal operation amount AP.

The brake pedal operation amount sensor 72 detects an amount of an operation applied to a brake pedal 31 of the vehicle 100 and sends a signal representing the detected amount of the operation to the ECU 90. The ECU 90 acquires the amount of the operation applied to the brake pedal 31 as a brake pedal operation amount BP, based on the received signal. The ECU 90 controls the activations of the braking apparatus 30, based on the acquired brake pedal operation amount BP.

The wheel speed sensor 80 includes a front left wheel speed sensor 81, a front right wheel speed sensor 82, a rear left wheel speed sensor 83, and a rear right wheel speed sensor 84.

The front left wheel speed sensor 81 sends a pulse signal to the ECU 90 each time the front left wheel 100FL of the vehicle 100 rotates by a predetermined angle. The ECU 90 acquires a rotation speed of the front left wheel 100FL as a front left wheel rotation speed VrFL, based on the received pulse signals.

The front right wheel speed sensor 82 sends a pulse signal to the ECU 90 each time the front right wheel 100FR of the vehicle 100 rotates by the predetermined angle. The ECU 90 acquires a rotation speed of the front right wheel 100FR as a front right wheel rotation speed VrFR, based on the received pulse signals.

The rear left wheel speed sensor 83 sends a pulse signal to the ECU 90 each time the rear left wheel 100RL of the vehicle 100 rotates by the predetermined angle. The ECU 90 acquires a rotation speed of the rear left wheel 100RL as a rear left wheel rotation speed VrRL, based on the received pulse signals.

The rear right wheel speed sensor 84 sends a pulse signal to the ECU 90 each time the rear right wheel 100RR of the vehicle 100 rotates by the predetermined angle. The ECU 90 acquires a rotation speed of the rear right wheel 100RR as a rear left wheel rotation speed VrRR, based on the received pulse signals.

The ECU 90 converts the acquired front left wheel rotation speed VrFL, the acquired front right wheel rotation speed VrFR, the acquired rear left wheel rotation speed VrRL, and the acquired rear right wheel rotation speed VrRR to moving speeds of the road wheels 100W relative to a road surface.

Hereinafter, the moving speed of the front left wheel 100FL to the road surface acquired by converting, will be referred to as “the front left wheel speed VFL.” Similarly, the moving speed of the front right wheel 100FR to the road surface acquired by converting, will be referred to as “the front right wheel speed VFR.” Similarly, the moving speed of the rear left wheel 100RL to the road surface acquired by converting, will be referred to as “the rear left wheel speed VRL.” Similarly, the moving speed of the rear right wheel 100RR to the road surface acquired by converting, will be referred to as “the rear right wheel speed VRR.” Further, the front left wheel speed VFL and the front right wheel speed VFR will be collectively referred to as “the front wheel speeds VF.” Similarly, the rear left wheel speed VRL and the rear right wheel speed VRR will be collectively referred to as “the rear wheel speeds VR.” Further, the front left wheel speed VFL, the front right wheel speed VFR, the rear left wheel speed VRL, and the rear right wheel speed VRR will be collectively referred to as “the road wheel speeds V.”

In addition, the ECU 90 acquires a vehicle body moving speed V100 by multiplying the highest wheel speed V of the acquired front left wheel speed VFL, the acquired front right wheel speed VFR, the acquired rear left wheel speed VRL, and the acquired rear right wheel speed VRR by a predetermined coefficient K.

The vehicle body moving speed V100 is a moving speed of a body of the vehicle 100 relative to the road surface. Further, the predetermined coefficient K is a coefficient which converts the highest wheel speed of four wheel speeds VFL, VFR, VRL, and VRR to a speed near the actual vehicle body moving speed in consideration of an amount of a slip of the road wheel relative to the road surface, i.e., “a slip ratio.” The predetermined coefficient K is preliminarily acquired by experiments.

<Summary of Operations>

Next, a summary of operations of the vehicle control apparatus 10 will be described.

The vehicle control apparatus 10 starts to execute an ordinary braking control when the vehicle control apparatus 10 determines that the brake pedal 31 is operated by a driver of the vehicle 100. The vehicle control apparatus 10 determines that the brake pedal 31 is operated by the driver when the brake pedal operation amount BP is larger than zero.

The ordinary braking control is a control to control the braking forces B to target values Btgt, respectively by (i) increasing the front wheel braking forces BF together at a predetermined increase rate RuN1 and (ii) increasing the rear wheel braking forces BR together at a predetermined increase rate RuN2. In this embodiment, the predetermined increase rate RuN1 is set to a value larger than the predetermined increase rate RuN2. It should be noted that a relationship in magnitude between the predetermined increase rates RuN1 and RuN2 is not limited to the relationship according to this embodiment.

While the vehicle control apparatus 10 executes the ordinary braking control, the vehicle control apparatus 10 calculates and acquires the target values Btgt of the braking forces B as described below. The vehicle control apparatus 10 calculates and acquires a total of the braking forces B to be applied to the vehicle 100 as a target total braking force Btotal, based on the brake pedal operation amount BP.

The vehicle control apparatus 10 distributes the acquired target total braking force Btotal at a predetermined distribution ratio to (i) a total front wheel braking force BFtotal to be applied to the front wheels F and (ii) a total rear wheel braking force BRtotal to be applied to the rear wheels R. In this embodiment, the predetermined distribution ratio distributes the target total braking force Btotal such that the total front wheel braking force BFtotal are larger than the total rear wheel braking force BRtotal. It should be noted that the predetermined distribution ratio is not limited to the predetermined distribution ratio according to this embodiment.

In addition, the vehicle control apparatus 10 sets a half of the total front wheel braking force BFtotal to be applied to the front wheels 100F as the target values Btgt of the front left wheel braking force BFL and the front right wheel braking force BFR, respectively. Similarly, the vehicle control apparatus 10 sets a half of the total rear wheel braking force BRtotal to be applied to the rear wheels 100R as the target values Btgt of the rear left wheel braking force BRL and the rear right wheel braking force BRR, respectively.

There is known a fact that a friction coefficient μ of the road wheel relative to the road surface becomes the highest value when the slip ratio of the road wheel relative to the road surface becomes a certain slip ratio. The certain slip ratio is, for example, between 10 percent and 20 percent. Hereinafter, the certain slip ratio will be referred to as “the optimum slip ratio SLopt.” When the braking forces are increased to brake the vehicle 100, the front wheel speeds and the rear wheel speeds together tend to decrease. As a result, the slip ratios of the road wheels 100W tend to increase. In order to achieve a short braking distance of the vehicle 100, the braking forces B should be controlled with preventing the slip ratios of the road wheels 100W from significantly exceeding the optimum slip ratio SLopt.

To this end, the vehicle control apparatus 10 monitors whether the wheel speeds V are larger than or equal to a lower limit wheel speed Vref. The lower limit wheel speed Vref is a value larger than the wheel speed which achieves the optimum slip ratio SLopt. In addition, the lower limit wheel speed Vref is a lower limit value of the wheel speed which achieves the acceptable braking distance of the vehicle. Hereinafter, the slip ratio of the road wheel 100W relative to the road surface, will be referred to as “the slip ratio SL.”

The vehicle control apparatus 10 calculates and acquires the lower limit wheel speed Vref as described below. In this embodiment, the slip ratio SL is defined by an expression “Slip Ratio SL=(Vehicle Body Moving Speed V100−Wheel Speed V)/(Vehicle Body Moving Speed V100).” In addition, in this embodiment, an upper limit slip ratio SLlimit has been preliminarily set. The upper limit slip ratio SLlimit is larger than the optimum slip ratio SLopt. In addition, the upper limit slip ratio SLlimit is an upper limit value of the slip ratio SL which achieves the acceptable braking distance of the vehicle. Therefore, the vehicle control apparatus 10 calculates and acquires the lower limit wheel speed Vref by an expression “Lower Limit Wheel Speed Vref=Vehicle Body Moving Speed V100−(Upper Limit Slip Ratio SLlimit*Vehicle Body Moving Speed V100).”

The vehicle control apparatus 10 continues executing the ordinary braking control as far as all of the wheel speeds V are larger than or equal to the lower limit wheel speed Vref. On the other hand, when any one of the wheel speeds V becomes smaller than the lower limit wheel speed Vref, the vehicle control apparatus 10 stops executing the ordinary braking control and starts to execute a wheel speed regaining control. The wheel speed regaining control includes (i) an initial front wheel braking force decrease control, (ii) an initial rear wheel braking force decrease control, and (iii) a wheel speed change control.

<Initial Front and Rear Wheel Braking Force Decrease Controls>

The initial front wheel braking force decrease control is a control to decrease the front wheel braking forces BF together at a predetermined decrease rate Rd1 during a predetermined period of time Td0_th. Thereby, the initial front wheel braking force decrease control is a control to decrease the front left wheel braking force BFL and the front right wheel braking force BFR at the predetermined decrease rate Rd1 during the predetermined period of time Td0_th. Further, the initial rear wheel braking force decrease control is a control to decrease the rear wheel braking forces BR together at a predetermined decrease rate Rd2 during the predetermined period of time Td0_th. Thereby, the initial rear wheel braking force decrease control is a control to decrease the rear left wheel braking force BRL and the rear right wheel braking force BRR at the predetermined decrease rate Rd2. Hereinafter, the decrease rate Rd1 for the initial front wheel braking force decrease control will be referred to as “the first decrease rate Rd1”, and the decrease rate Rd2 for the initial rear wheel braking force decrease control will be referred to as “the second decrease rate Rd2.” In this embodiment, the first decrease rate Rd1 is larger than the second decrease rate Rd2. It should be noted that a relationship in magnitude between the first decrease rate Rd1 and the second decrease rate Rd2 is not limited to the relationship according to this embodiment.

<Wheel Speed Change Control>

The wheel speed change control includes (i) a rear wheel braking force maintaining control, a first increase-decrease control, and a second increase-decrease control.

<Rear Wheel Maintaining Control>

The rear wheel braking force maintaining control is a control to maintain the rear braking forces BR at ones which have been controlled at a point of time when the rear wheel braking force maintaining control starts to be executed.

<First Increase-Decrease Control>

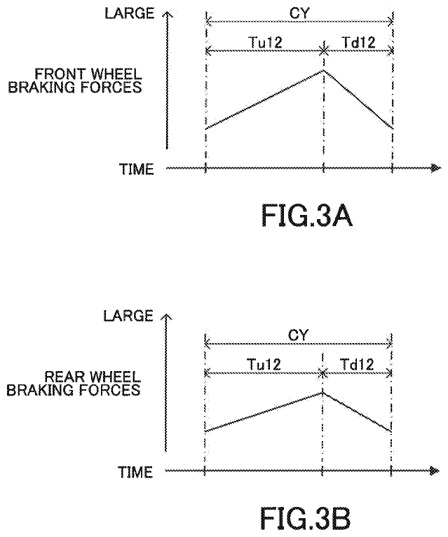

As shown in FIG. 3A, the first increase-decrease control is a control to (i) execute a first increase control to increase the front wheel braking forces BF together at a predetermined increase rate Ru1 during a predetermined period of time Tu12 and then, (ii) execute a first decrease control to decrease the front wheel braking forces BF together at the first decrease rate Rd1 during a predetermined period of time Td12. Hereinafter, the increase rate Ru1 for the first increase control will be referred to as “the first increase rate Ru1.” In addition, the predetermined period of time Tu12 will be referred to as “the predetermined increase period of time Tu12”, and the predetermined time Td12 will be referred to as “the predetermined decrease period of time Td12.”

In this embodiment, the front left wheel braking force BFL and the front right wheel braking force BFR are maintained at the same value while the first increase-decrease control is executed. It should be noted that a relationship in magnitude between the front left wheel braking force BFL and the front right wheel braking force BFR while the first increase-decrease control is executed, is not limited to the relationship according to this embodiment.

Further, in this embodiment, the predetermined increase amount of time Tu12 is shorter than the predetermined decrease amount of time Td12. It should be noted that a relationship in length between the predetermined increase amount of time Tu12 and the predetermined decrease amount of time Td12 is not limited to the relationship according to this embodiment.

Further, in this embodiment, the first increase rate Ru1 is smaller than the first decrease rate Rd1. It should be noted that a relationship in magnitude between the first increase rate Ru1 and the first decrease rate Rd1 is not limited to the relationship according to this embodiment.

<Second Increase-Decrease Control>

As shown in FIG. 3B, the second increase-decrease control is a control to (i) execute a second increase control to increase the rear wheel braking forces BR together at a predetermined increase rate Ru2 during the predetermined increase period of time Tu12 and then, (ii) execute a second decrease control to decrease the rear wheel braking forces BR together at the second decrease rate Rd2 during the predetermined decrease period of time Td12. Hereinafter, the increase rate Ru2 for the second increase control will be referred to as “the second increase rate Ru2.”

In this embodiment, the rear left wheel braking force BRL and the rear right wheel braking force BRR are maintained at the same value while the second increase-decrease control is executed. It should be noted that a relationship in magnitude between the rear left wheel braking force BRL and the rear right wheel braking force BRR while the second increase-decrease control is executed, is not limited to the relationship according to this embodiment.

Further, in this embodiment, the second increase rate Ru2 is smaller than the second decrease rate Rd2. It should be noted that a relationship in magnitude between the second increase rate Ru2 and the second decrease rate Rd2 is not limited to the relationship according to this embodiment.

Further, in this embodiment, the second increase rate Ru2 is smaller than the first increase rate Ru1. It should be noted that a relationship in magnitude between the second increase rate Ru2 and the first increase rate Ru1 is not limited to the relationship according to this embodiment.

Further, in this embodiment, the second decrease rate Rd2 is smaller than the first decrease rate Rd1. It should be noted that a relationship in magnitude between the second decrease rate Rd2 and the first decrease rate Rd1 is not limited to the relationship according to this embodiment.

When the vehicle control apparatus 10 starts to execute the wheel speed regaining control, the vehicle control apparatus 10 starts to execute the initial front wheel braking force decrease control and the initial rear wheel braking force decrease control. Thereby, the front wheel braking forces BF are decreased together, and the rear wheel braking forces BR are decreased together. As a result, the front wheel speeds VF and the rear wheel speeds VR increase together.

The vehicle control apparatus 10 continues executing the initial front and rear wheel braking force decrease controls until an amount of time Td0 elapsing from when the initial front and rear wheel braking force decrease controls start to be executed, reaches the predetermined amount of time Td0_th. Hereinafter, the amount of time Td0 elapsing from when the initial front and rear wheel braking force decrease controls start to be executed, will be referred to as “the decrease amount of time Td0.”

When the decrease amount of time Td0 reaches the predetermined amount of time Td0_th, the vehicle control apparatus 10 stops executing the initial front and rear wheel braking force decrease controls and starts to execute the wheel speed change control. When the vehicle control apparatus 10 starts to execute the wheel speed change control, the vehicle control apparatus 10 starts to execute the first increase-decrease control and the rear wheel braking force maintaining control. Thereby, the front braking forces BF are increased together. Then, the front wheel braking are decreased together until the predetermined decrease amount of time Td12 elapses from when the predetermined increase amount of time Tu12 elapses. As a result, the front wheel speeds VF decrease together and then, increase together. Further, the rear wheel braking forces BR are maintained at the values controlled at a point of time when the rear wheel braking force maintaining control starts to be executed. As a result, the rear wheel speeds VR continues increasing together.

The vehicle control apparatus 10 repeatedly executes the first increase-decrease control as far as a predetermined stop condition is not satisfied. Therefore, the vehicle control apparatus 10 repeatedly executes the first increase-decrease control with a predetermined cycle CY (=Predetermined Increase Amount of Time Tu12+Predetermined Decrease Amount of Time Td12). The predetermined stop condition here becomes satisfied when a state that all of the wheel speeds V are higher than or equal to the lower limit wheel speed Vref continues for a predetermined amount of time Tg0_th while the vehicle speed change control is executed. In this embodiment, the predetermined amount of time Tg0_th is set to an amount of time longer than the predetermined cycle CY. Hereinafter, an amount of time which the state that all of the wheel speeds V are higher than or equal to the lower limit wheel speed Vref continues while the vehicle speed change control is executed, will be referred to as “the speed regained amount of time Tg0.”

Further, the vehicle control apparatus 10 stops executing the rear wheel braking force maintaining control and starts to execute the second increase-decrease control when a half cycle amount of time Tcyh elapses from when the first increase-decrease control starts to be executed. The half cycle amount of time Tcyh corresponds to a cycle CYH which is a half of the predetermined cycle CY. Hereinafter, the cycle CYH which is a half of the predetermined cycle CY will be referred to as “the half cycle CYH.” When the second increase-decrease control starts to be executed, the rear wheel braking forces BR are increased together. Then, the rear wheel braking forces BR are decreased together until the predetermined decrease amount of time Td12 elapses from when the predetermined increase amount of time Tu12 elapses. As a result, the rear wheel speeds VR decrease and then, increase.

The vehicle control apparatus 10 repeatedly executes the second increase-decrease control as far as the predetermined stop condition is not satisfied. Therefore, the vehicle control apparatus 10 repeatedly executes the second increase-decrease control with the predetermined cycle CY (=Predetermined Increase Amount of Time Tu12+Predetermined Decrease Amount of Time Td12).

As understood from the above, the vehicle control apparatus 10 repeatedly and alternately executes the first and second increase-decrease controls with the half cycle CYH until the predetermined stop condition becomes satisfied.

When the predetermined stop condition becomes satisfied, the vehicle control apparatus 10 stops executing the wheel speed regaining control and restarts to execute the ordinary braking control.

It should be noted that the vehicle control apparatus 10 clears the speed regaining amount of time Tg0 when any one of the wheel speeds V becomes lower than the lower limit wheel speed Vref before the speed regaining amount of time Tg0 reaches the predetermined amount of time Tg0_th. In addition, the vehicle control apparatus 10 clears the speed regaining amount of time Tg0 when the vehicle control apparatus 10 stops executing the wheel speed regaining control.

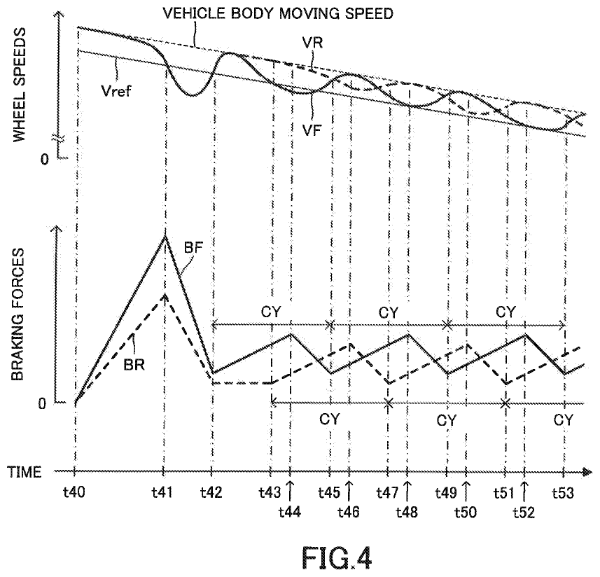

While the wheel speed regaining control is executed, the braking forces B are controlled, and the wheel speeds V change, for example, as shown in FIG. 4. In FIG. 4, the front wheel braking forces BF and the front wheel speeds VF are shown by solid lines, and the rear wheel braking forces BR and the rear wheel speeds VR are shown by chain lines.

In an example shown in FIG. 4, the ordinary braking control starts to be executed at a point of time t40. Thereby, the front wheel braking forces BF and the rear wheel braking forces BR starts to be increased together. As a result, the front wheel speeds VF and the rear wheel speeds VR starts to decrease together.

Then, at a point of time t41, the front wheel speeds VF and the rear wheel speeds VR reach the lower limit wheel speed Vref. Thus, at the point of time t41, the initial front and rear wheel braking force decrease controls start to be executed. Thereby, the front wheel braking forces BF and the rear wheel braking forces BR start to be decreased together. As a result, the front wheel speeds VF and the rear wheel speeds VR starts to increase together after the front wheel speeds VF and the rear wheel speeds VR become lower than the lower limit wheel speed Vref.

Then, at a point of time t42, the front wheel speeds VF and the rear wheel speeds VR reach the lower limit wheel speed Vref. Thus, at the point of time t42, the wheel speed regaining control starts to be executed. When the wheel speed regaining control starts to be executed, the first increase control and the rear wheel braking force maintaining control of the first increase-decrease control start to be executed. Thereby, the front wheel braking forces BF starts to be increased, and the rear wheel braking forces BR starts to be maintained. As a result, the front wheel speeds VF starts to decrease after the front wheel speed VF become higher than the lower limit wheel speed Vref. On the other hand, the rear wheel speeds VR continue increasing and then, decrease with the vehicle body moving speed decreasing.

Then, at a point of time t43, the half cycle Tcyh elapses from when the first increase control starts to be executed at the point of time t42. Thus, at the point of time t43, the second increase control of the second increase-decrease control starts to be executed. Thereby, the rear wheel braking forces BR start to be increased. As a result, the rear wheel speeds VR start to decrease. At this time, the first increase control continues being executed. Thereby, the front wheel speeds VF continues decreasing and, in the example shown in FIG. 4, become lower than the lower limit wheel speed Vref.

Then, at a point of time t44, the first decrease control of the first increase-decrease control starts to be executed. Thereby, the front wheel braking forces BF start to be decreased. As a result, the front wheel speeds VF start to increase and, in the example shown in FIG. 4, become higher than the lower limit wheel speed Vref. At this time, the second increase control continues being executed. Thereby, the rear wheel speeds VR continue decreasing.

Then, at a point of time t45, the first increase control starts to be executed. Thereby, the front wheel braking forces BF start to be increased. As a result, the front wheel speeds VF slightly increase and then, decrease. At this time, the second increase control continues being executed. Thereby, the rear wheel speeds VR continue decreasing.

Then, at a point of time t46, the second decrease control starts to be executed. Thereby, the rear wheel braking forces BR start to be decreased. As a result, the rear wheel speeds VR starts to increase. At this time, the first increase control continues being executed. Thereby, the front wheel speeds VF continue decreasing.

Then, at a point of time t47, the second increase control starts to be executed. Thereby, the rear wheel braking forces BR start to be increased. As a result, the rear wheel speeds VR slightly increase and then, decrease. At this time, the first increase control continues being executed. Thereby, the front wheel speeds VF continue decreasing.

Then, the first and second increase-decrease controls are repeatedly and alternately executed with the half cycle CYH until the predetermined stop condition becomes satisfied.

<Effects>

There are the proper wheel speeds to achieve the short braking distance of the vehicle (in this embodiment, the lower limit wheel speed Vref). If the braking forces applied to the road wheels are separately increased and decreased in order to control the wheel speeds lower than the proper wheel speed to the proper wheel speed while the vehicle is braked, all of the wheel speeds may simultaneously decrease to a larger extent than a decrease of the actual vehicle body moving speed. When all of the wheel speeds simultaneously decrease to the larger extent than the decrease of the actual vehicle body moving speed, the exact vehicle body moving speed cannot be acquired. Thus, it takes a large amount of time to control the wheel speeds to the proper wheel speeds. As a result, the braking distance of the vehicle 100 increases. Therefore, the short braking distance of the vehicle can be achieved by preventing all of the vehicle speeds from simultaneously decreasing to the larger extent than the decrease of the actual vehicle body moving speed.

As understood from the above description, a process to separately increase and decrease the braking forces applied to the road wheels makes all of the wheel speeds simultaneously decrease to the larger extent than the decrease of the actual vehicle body moving speed.

With the vehicle control apparatus 10, the front wheel braking forces BF are increased together and decreased together while the vehicle speed change control is executed. Therefore, when one of the front wheel braking forces BF is increased, the other front wheel braking force BF is also increased. In addition, when one of the front wheel braking forces BF is decreased, the other front wheel braking force BF is also decreased. Thus, the front wheel braking forces BF are not separately increased and decreased. Thus, both of the front wheel speeds VF may not simultaneously decrease to the larger extent than the decrease of the actual vehicle body moving speed V100. Therefore, all of the wheel speeds V can be prevented from simultaneously decreasing to the larger extent than the decrease of the actual vehicle body moving speed V100.

Similarly, with the vehicle control apparatus 10, the rear wheel braking forces BR are increased together and decreased together while the vehicle speed change control is executed. Therefore, when one of the rear wheel braking forces BR is increased, the other rear wheel braking force BR is also increased. In addition, when one of the rear wheel braking forces BR is decreased, the other rear wheel braking force BR is also decreased. Thus, the rear wheel braking forces BR are not separately increased and decreased. Thus, both of the rear wheel speeds VR may not simultaneously decrease to the larger extent than the decrease of the actual vehicle body moving speed V100. Therefore, all of the wheel speeds V can be prevented from simultaneously decreasing to the larger extent than the decrease of the actual vehicle body moving speed V100.

In addition, with the vehicle control apparatus 10, in general, the rear wheel braking forces BR are decreased when the front wheel braking forces BF are increased while the first increase-decrease control and the second increase-decrease control are executed. In addition, in general, the front wheel braking forces BF are decreased when the rear wheel braking forces BR are increased while the first increase-decrease control and the second increase-decrease control are executed. Therefore, when the front wheel speeds VF decrease, the rear wheel speeds VR increase. On the other hand, when the rear wheel speeds VR decrease, the front wheel speeds VF increase. Thus, all of the wheel speeds V can be prevented from simultaneously decreasing to the larger than the decrease of the actual vehicle body moving speed V100.

As described above, the vehicle control apparatus 10 (i) starts to execute the first increase-decrease control and the rear wheel braking force maintaining control when the decrease amount of time Td0 reaches the predetermined amount of time Td0_th, (ii) stops executing the rear wheel braking force maintaining control and starts to execute the second increase-decrease control when the half cycle Tcyh elapses from when the first increase-decrease control and the rear wheel braking force maintaining control starts to be executed, and (iii) repeatedly and alternately executes the first and second increase-decrease controls with the half cycle CYH as far as the predetermined stop condition is not satisfied.

It should be noted that the vehicle control apparatus 10 may be configured to (i) start to execute the second increase-decrease control and a front wheel braking force maintaining control when the decrease amount of time Td0 reaches the predetermined amount of time Td0_th, (ii) stop executing the front wheel braking force maintaining control and start to execute the first increase-decrease control when the half cycle Tcyh elapses from when the second increase-decrease control and the front wheel braking force maintaining control starts to be executed, and (iii) repeatedly and alternately execute the first and second increase-decrease controls with the half cycle CYH as far as the predetermined stop condition is not satisfied. The front wheel braking force maintaining control is a control to maintain the front wheel braking forces BF at the values controlled at a point of time when the front wheel braking force maintaining control starts to be executed.

Further, it should be noted that the vehicle control apparatus 10 may be configured to determine whether to start to execute the first increase-decrease control and the rear wheel braking force maintaining control or execute the second increase-decrease control and the front wheel braking force maintaining control, depending on the current wheel speeds Vat a point of time when the decrease amount of time Td0 reaches the predetermined amount of time Td0_th.

Further, the vehicle control apparatus 10 stops executing the ordinary braking control when the driver releases the brake pedal 31 while the vehicle control apparatus 10 executes the ordinary braking control. Further, the vehicle control apparatus 10 stops executing the wheel speed regaining control when the driver releases the brake pedal 31 while the vehicle control apparatus 10 executes the wheel speed regaining control.

It should be noted that the vehicle control apparatus 10 may be configured to (i) execute the first increase-decrease control to control the front left wheel braking force BFL and the rear left wheel braking force BRL and (ii) execute the second increase-decrease control to control the front right wheel braking force BFR and the rear right wheel braking force BRR.

In this case, the first increase-decrease control is a control to (i) execute the first increase control to increase the front left wheel braking force BFL and the rear left wheel braking force BRL together at the first increase rate Ru1 for the predetermined increase amount of time Tu12 and then, (ii) execute the first decrease control to decrease the front left wheel braking force BFL and the rear left wheel braking force BRL together at the first decrease rate Rd1 for the predetermined decrease amount of time Td12.

Further, the second increase-decrease control is a control to (i) execute the second increase control to increase the front right wheel braking force BFR and the rear right wheel braking force BRR together at the second increase rate Rut for the predetermined increase amount of time Tu12 and then, (ii) execute the second decrease control to decrease the front right wheel braking force BFR and the rear right wheel braking force BRR together at the second decrease rate Rd2 for the predetermined decrease amount of time Td12.

In addition, in this case, the vehicle control apparatus 10 is configured to execute a maintaining control described below in place of executing the rear wheel braking force maintaining control. That is, the vehicle control apparatus 10 is configured to execute the maintaining control to maintain the front right wheel braking force BFR and the rear right wheel braking force BRR at the values controlled at a point of time when the vehicle control apparatus 10 starts to execute the maintaining control.

<Concrete Operations>

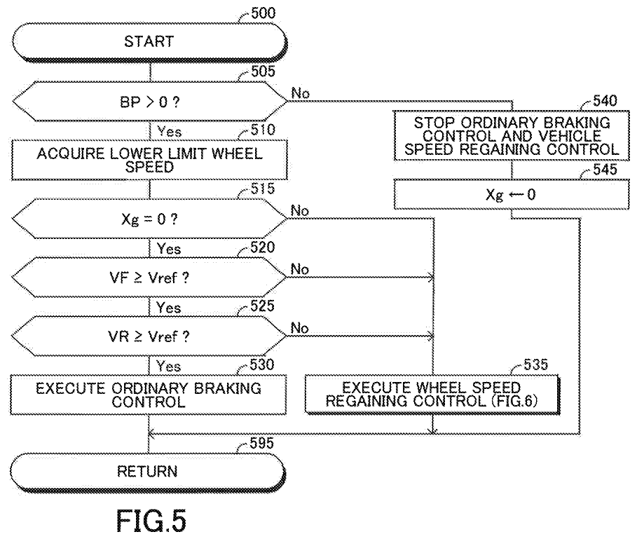

Next, concrete operations of the vehicle control apparatus 10 will be described. The CPU of the ECU 90 of the vehicle control apparatus 10 is configured or programmed to execute a routine shown in FIG. 5 each time a predetermined time Tc elapses.

Therefore, at a predetermined timing, the CPU starts to execute a process from a step 500 in FIG. 5 and proceeds with the process to a step 505 to determine whether the brake pedal operation amount BP is larger than zero.

When the CPU determines “Yes” at the step 505, the CPU proceeds with the process to a step 510 to calculate and acquire the lower limit wheel speed Vref. Next, the CPU proceeds with the process to a step 515 to determine whether a value of a wheel speed regaining control flag Xg is “0.” The value of the wheel speed regaining control flag Xg is set to “1” when the wheel speed regaining control starts to be executed. On the other hand, the value of the wheel speed regaining control flag Xg is set to “0” when the wheel speed regaining control stops being executed.

When the CPU determines “Yes” at the step 515, the CPU proceeds with the process to a step 520 to determine whether the front wheel speeds VF are higher than or equal to the lower limit wheel speed Vref.

When the CPU determines “Yes” at the step 520, the CPU proceeds with the process to a step 525 to determine whether the rear wheel speeds VR are higher than or equal to the lower limit wheel speed Vref.

When the CPU determines “Yes” at the step 525, the CPU proceeds with the process to a step 530 to execute the ordinary braking control. Next, the CPU proceeds with the process to a step 595 to terminate executing this routine once.

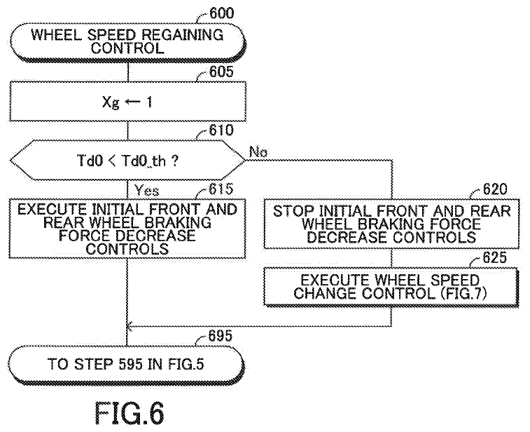

On the other hand, when the CPU determines “No” at the step 515 or 520 or 525, the CPU proceeds with the process to a step 535 to execute the wheel speed regaining control. The wheel speed regaining control is realized by executing a routine shown in FIG. 6.

Therefore, when the CPU proceeds with the process to the step 535, the CPU starts a process from a step 600 in FIG. 6 and proceeds with the process to a step 605 to set the value of the wheel speed regaining control flag Xg to “1.” Thereby, when the CPU proceeds with the process to the step 515 in FIG. 5, the CPU determines “No.” Next, the CPU proceeds with the process to a step 610 to determine whether the decrease amount of time Td0 is shorter than the predetermined amount of time Td0_th.

When the CPU determines “Yes” at the step 610, the CPU proceeds with the process to a step 615 to execute the initial front and rear wheel braking force decrease controls. Next, the CPU proceeds with the process to the step 595 in FIG. 5 via a step 695 to terminate executing this routine once.

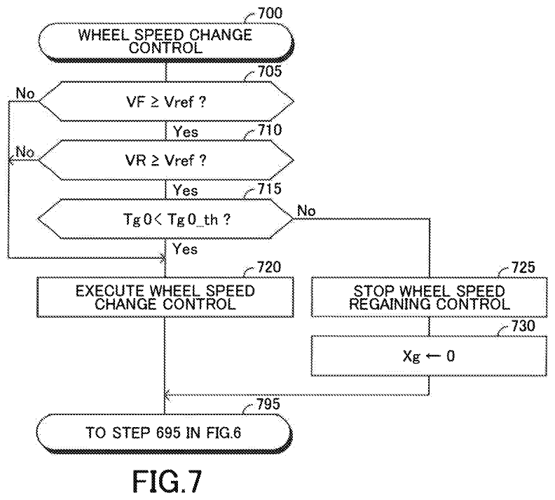

On the other hand, when the CPU determines “No” at the step 610, the CPU proceeds with the process to a step 620 to stop executing the initial front and rear wheel braking force decrease controls. Next, the CPU proceeds with the process to a step 625 to execute the wheel speed change control. The wheel speed change control is realized by executing a routine shown in FIG. 7.

Therefore, when the CPU proceeds with the process to the step 625, the CPU starts a process from a step 700 in FIG. 7 and proceeds with the process to a step 705 to determine whether the front wheel speeds VF are higher than or equal to the lower limit wheel speed Vref.

When the CPU determines “Yes” at the step 705, the CPU proceeds with the process to a step 710 to determine whether the rear wheel speeds VR are higher than or equal to the lower limit wheel speed Vref.

When the CPU determines “Yes” at the step 710, the CPU proceeds with the process to a step 715 to determine whether a speed regaining amount of time Tg0 is shorter than the predetermined amount of time Tg0_th. The speed regaining amount of time Tg0 is an amount of time elapsing from when the CPU determines “Yes” at the steps 705 and 710 after the wheel speed change control starts to be executed. The speed regaining amount of time Tg0 is cleared when the CPU determines “No” at the step 705 or 710 after the CPU determines “Yes” at the steps 705 and 710.

When the CPU determines “Yes” at the step 715, the CPU proceeds with the process to a step 720 to execute the wheel speed change control. Thereby, the first increase-decrease control and the rear wheel braking force maintaining control start to be execute. Then, the rear wheel braking force maintaining control stops being executed, and the second increase-decrease control starts to be executed when the half cycle Tcyh elapses. Then, the first and second increase-decrease controls are repeatedly and alternately executed with the half cycle CYH as far as the predetermined stop condition is not satisfied. Next, the CPU proceeds with the process to the step 595 in FIG. 5 via a step 795 and the step 695 in FIG. 6 to terminate executing this routine once.

On the other hand, when the CPU determines “No” at the step 715, the CPU proceeds with the process to a step 725 to stop executing the wheel speed regaining control. Thereby, the wheel speed change control stops being executed.

Next, the CPU proceeds with the process to a step 730 to set the value of the wheel speed regaining control flag Xg to “0.” Thereby, when the CPU proceeds with the process to the step 515 in FIG. 5, the CPU determines “Yes.” Next, the CPU proceeds with the process to the step 595 via the step 795 and the step 695 in FIG. 6 to terminate executing this routine once.

When the CPU determines “No” at the step 705 or 710, the CPU proceeds with the process to the step 720 to execute the wheel speed change control. Next, the CPU proceeds with the process to the step 595 via the step 795 and the step 695 in FIG. 6 to terminate executing this routine once.

When the CPU determines “No” at the step 505 in FIG. 5, the CPU proceeds with the process to a step 540 to (i) stop executing the ordinary braking control if the CPU executes the ordinary braking control and (ii) stop executing the wheel speed regaining control if the CPU executes the wheel speed regaining control. Next, the CPU proceeds with the process to a step 545 to set the value of the wheel speed regaining control flag Xg to “0.” Next, the CPU proceeds with the process to the step 595 to terminate executing this routine once.

The concrete operations of the vehicle 100 have been described. When the vehicle control apparatus 10 executes the routines shown in FIGS. 5-7, the front wheel braking forces BF are increased together and decreased together while the wheel speed change control is executed. Therefore, the front wheel braking forces BF are not separately increased and decreased. In addition, the rear wheel braking forces BR are increased together and decreased together while the wheel speed change control is executed. Therefore, the rear wheel braking forces BR are not separately increased and decreased. Thus, all of the wheel speeds V can be prevented from simultaneously decreasing to the larger extent than the decrease of the actual vehicle body moving speed V100.

In addition, when the first and second increase-decrease controls are executed, the rear wheel speeds VR increase while the front wheel speeds VF decrease, and the front wheel speeds VF increase while the rear wheel speeds VR decrease. Thus, all of the wheel speeds V can be prevented from simultaneously decreasing to the larger extent than the decrease of the actual vehicle body moving speed V100.

It should be noted that the present disclosure is not limited to the aforementioned embodiment, and various modifications can be employed within the scope of the present disclosure.

<First Modified Example>

For example, the vehicle control apparatus 10 according to a first modified example of the embodiment of the present disclosure executes the wheel speed regaining control as described below. Hereinafter, the vehicle control apparatus 10 according to the first modified example will be simply referred to as “the vehicle control apparatus 10.”

<Summary of Operations>

The vehicle control apparatus 10 executes the ordinary braking control described above when the vehicle control apparatus 10 determines that the driver operates the brake pedal 31. When any one of the wheel speeds V becomes lower than the lower limit wheel speed Vref while the vehicle control apparatus 10 executes the ordinary braking control, the vehicle control apparatus 10 stops executing the ordinary braking control and starts to execute the wheel speed regaining control. The wheel speed regaining control according to the first modified example includes a wheel speed change control described below in addition to the initial front and rear wheel braking force decrease controls described above.

<Wheel Speed Change Control>

The wheel speed change control according to the first modified example includes (i) a first increase control, (ii) a first decrease control, (iii) a second increase control, and (iv) a second decrease control described below in addition to the rear wheel braking force maintaining control described above.

<First Increase Control>

The first increase control is a control to increase the front wheel braking forces BF together at the first increase rate Ru1.

In the first modified example, the front left wheel braking force BFL and the front right wheel braking force BFR are maintained at the same value while the first increase control is executed. It should be noted that a relationship in magnitude between the front left wheel braking force BFL and the front right wheel braking force BFR while the first increase control is executed, is not limited to the relationship according to the first modified example.

<First Decrease Control>

The first decrease control is a control to (i) decrease the front wheel braking forces BF together at the first decrease rate Rd1 until the front wheel speeds VF reach a regaining determination threshold Vg and (ii) after when the front wheel speeds VF reach the regaining determination threshold Vg, maintain the front wheel braking forces BF at the values controlled at a point of time when the front wheel speeds VF reach the regaining determination threshold Vg. The regaining determination threshold Vg is set to a value larger than the lower limit wheel speed Vref and smaller than the vehicle body moving speed.

In the first modified example, the front left wheel braking force BFL and the front right wheel braking force BFR are maintained at the same values while the first decrease control is executed. It should be noted that a relationship in magnitude between the front left wheel braking force BFL and the front right wheel braking force BFR while the first decrease control is executed, is not limited to the relationship according to the first modified example.

<Second Increase Control>

The second increase control is a control to increase the rear wheel braking forces BR together at the second increase rate Rut.

In the first modified example, the rear left wheel braking force BRL and the rear right wheel braking force BRR are maintained at the same values while the second increase control is executed. It should be noted that a relationship in magnitude between the rear left wheel braking force BRL and the rear right wheel braking force BRR while the second increase control is executed, is not limited to the relationship according to the first modified example.

<Second Decrease Control>

The second decrease control is a control to (i) decrease the rear wheel braking forces BR together at the second decrease rate Rd2 until the rear wheel speeds VR reach the regaining determination threshold Vg and (ii) after the rear wheel speeds VR reach the regaining determination threshold Vg, maintain the rear wheel braking forces BR at the values controlled at a point of time when the rear wheel speeds VR reach the regaining determination threshold Vg.

In the first modified example, the rear left wheel braking force BRL and the rear right wheel braking force BRR are maintained at the same value while the second decrease control is executed. It should be noted that a relationship in magnitude between the rear left wheel braking force BRL and the rear right wheel braking force BRR while the second decrease control is executed, is not limited to the relationship according to the first modified example.

When the vehicle control apparatus 10 starts to execute the wheel speed regaining control, the vehicle control apparatus 10 starts to execute the initial front and rear wheel braking force decrease controls. Thereby, the front wheel braking forces BF are decreased together, and the rear wheel braking forces BR are decreased together. As a result, the front wheel speeds VF and the rear wheel speeds VR increase together.

The vehicle control apparatus 10 continues executing the initial front and rear wheel braking force decrease controls until any one of the front wheel speeds VF and any one of the rear wheel speeds VR become equal to or higher than the regaining determination threshold Vg. It should be noted that the vehicle control apparatus 10 may be configured to continue executing the initial front and rear wheel braking force decrease controls until all of the front wheel speeds VF and the rear wheel speeds VR become equal to or higher than the regaining determination threshold Vg. Alternatively, the vehicle control apparatus 10 may be configured to continue executing the initial front and rear wheel braking force decrease controls until an average of the front wheel speeds VF and an average of the rear wheel speeds VR become equal to or higher than the regaining determination threshold Vg.

The vehicle control apparatus 10 stops executing the initial front and rear wheel braking force decrease controls and starts to execute the wheel speed change control when any one of the front wheel speeds VF and any one of the rear wheel speeds VR become equal to or higher than the regaining determination threshold Vg. When the vehicle control apparatus 10 starts to execute the wheel speed change control, the vehicle control apparatus 10 starts to execute the first increase control and the rear wheel braking force maintaining control. Thereby, the front wheel braking forces BF are increased together, and the rear wheel braking forces BR are maintained at the values controlled at a point of time when the rear wheel braking force maintaining control starts to be executed. As a result, the front wheel speeds VF decrease together, and the rear wheel speeds VR continue increasing.

The vehicle control apparatus 10 continues executing the first increase control and the rear wheel braking force maintaining control until any one of the front wheel speeds VF becomes lower than the lower limit wheel speed Vref while the vehicle control apparatus 10 executes the first increase control and the rear wheel braking force maintaining control. It should be noted that the vehicle control apparatus 10 may be configured to continue executing the first increase control and the rear wheel braking force maintaining control until both of the front wheel speeds VF become lower than the lower limit wheel speed Vref. Alternatively, the vehicle control apparatus 10 may be configured to continue executing the first increase control and the rear wheel braking force maintaining control until an average of the front wheel speeds VF becomes lower than the lower limit wheel speed Vref.

The vehicle control apparatus 10 stops executing the first increase control and the rear wheel braking force maintaining control and starts to execute the first decease control and the second increase control when any one of the front wheel speeds VF becomes lower than the lower limit wheel speed Vref while the vehicle control apparatus 10 executes the first increase control and the rear wheel braking force maintaining control. Thereby, the front wheel braking forces BF are decreased together, and the rear wheel braking forces BR are increased together. As a result, the front wheel speeds VF increase together, and the rear wheel speeds VR decrease together.

The vehicle control apparatus 10 continues executing the first decrease control and the second increase control until any one of the rear wheel speeds VR becomes lower than the lower limit wheel speed Vref or as far as the predetermined stop condition is not satisfied. The predetermined stop condition here becomes satisfied when a state that both of the rear wheel speeds VR are equal to or higher than the lower limit wheel speed Vref, continues for a predetermined amount of time Tg2_th while the first decrease control and the second increase control are executed. Hereinafter, an amount of time which the state that both of the rear wheel speeds VR are equal to or higher than the lower limit wheel speed Vref, continues, will be referred to as “the rear wheel speed regaining amount of time Tg2.”

It should be noted that the vehicle control apparatus 10 may be configured to determine that the predetermined stop condition becomes satisfied when both of the rear wheel speeds VR become higher than or equal to the lower limit wheel speed Vref while the first decrease control and the second increase control are executed.

In the first modified example, the vehicle control apparatus 10 continues executing the first decrease control and the second increase control until any one of the rear wheel speeds VR becomes lower than the lower limit wheel speed Vref. It should be noted that the vehicle control apparatus 10 may be configured to continue executing the first decrease control and the second increase control until both of the rear wheel speeds VR become lower than the lower limit wheel speed Vref. Alternatively, the vehicle control apparatus 10 may be configured to continue executing the first decrease control and the second increase control until an average of the rear wheel speeds VR becomes lower than the lower limit wheel speed Vref.

The vehicle control apparatus 10 stops executing the first decrease control and the second increase control and starts to execute the first increase control and the second decrease control when any one of the rear wheel speeds VR becomes lower than the lower limit wheel speed Vref while the vehicle control apparatus 10 executes the first decrease control and the second increase control. Thereby, the front wheel braking forces BF are increased together, and the rear wheel braking forces BR are decreased together. As a result, the front wheel speeds VF decrease together, and the rear wheel speeds VR increase together.

The vehicle control apparatus 10 continues executing the first increase control and the second decrease control until any one of the front wheel speeds VF becomes lower than the lower limit wheel speed Vref or as far as the predetermined stop condition is not satisfied. The predetermined stop condition here becomes satisfied when a state that both of the front wheel speeds VF are equal to or higher than the lower limit wheel speed Vref, continues for a predetermined amount of time Tg1_th while the first increase control and the second decrease control are executed. Hereinafter, an amount of time which the state that both of the front wheel speeds VF are equal to or higher than the lower limit wheel speed Vref, continues, will be referred to as “the front wheel speed regaining amount of time Tg1.”

It should be noted that the vehicle control apparatus 10 may be configured to determine that the predetermined stop condition becomes satisfied when both of the front wheel speeds VF become higher than or equal to the lower limit wheel speed Vref while the first increase control and the second decrease control are executed.

In the first modified example, the vehicle control apparatus 10 continues executing the first increase control and the second decrease control until any one of the front wheel speeds VF becomes lower than the lower limit wheel speed Vref. It should be noted that the vehicle control apparatus 10 may be configured to continue executing the first increase control and the second decrease control until both of the front wheel speeds VF become lower than the lower limit wheel speed Vref. Alternatively, the vehicle control apparatus 10 may be configured to continue executing the first increase control and the second decrease control until an average of the front wheel speeds VF becomes lower than the lower limit wheel speed Vref.

The vehicle control apparatus 10 repeatedly and alternately executes (i) the first decrease control and the second increase control and (ii) the first increase control and the second decrease control as far as the predetermined stop condition is not satisfied.

When the predetermined stop condition becomes satisfied while the vehicle control apparatus 10 executes the wheel speed change control, the vehicle control apparatus 10 stops executing the wheel speed regaining control and starts to execute the ordinary braking control.

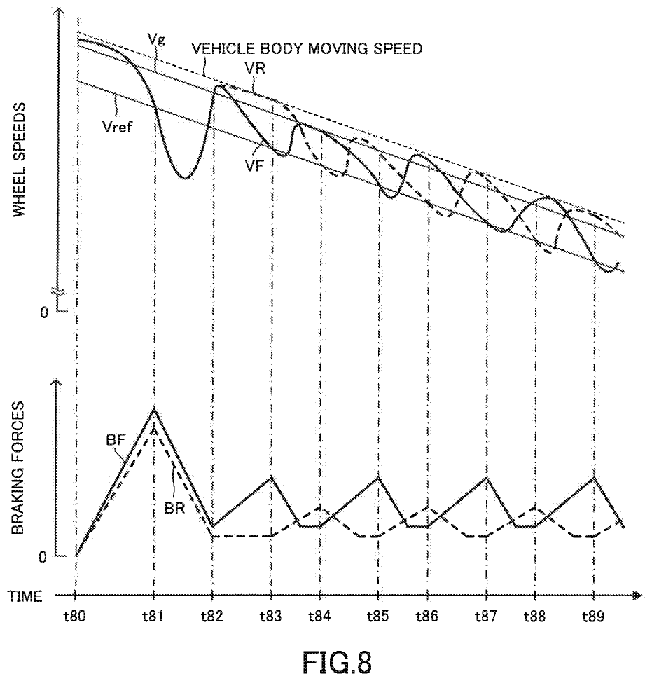

When the wheel speed regaining control is executed, the braking forces B are controlled, and the wheel speeds V change, for example, as shown in FIG. 8. In FIG. 8, the front wheel braking forces BF and the front wheel speeds VF are shown by solid lines, and the rear wheel braking forces BR and the rear wheel speeds VR are shown by chain lines.

In an example shown in FIG. 8, the ordinary braking control starts to be executed at a point of time t80. Thereby, the front wheel braking forces BF and the rear wheel braking forces BR start to be increased together. As a result, the front wheel speeds VF and the rear wheel speeds VR starts to decrease together.

Then, at a point of time t81, the front wheel speeds VF and the rear wheel speeds VR reaches the lower limit wheel speed Vref. Thus, at the point of time t81, the initial front and rear wheel braking force decrease controls start to be executed. Thereby, the front wheel braking forces BF and the rear wheel braking forces BR start to be decreased together. As a result, the front wheel speeds VF and the rear wheel speeds VR increase together after the front wheel speeds VF and the rear wheel speeds VR become lower than the lower limit wheel speed Vref.

Then, at a point of time t82, the front wheel speeds VF and the rear wheel speeds VR reach the regaining determination threshold Vg. Thus, at the point of time t82, the wheel speed regaining control starts to be executed. When the wheel speed regaining control starts to be executed, the first increase control and the rear wheel braking force maintaining control start to be executed. Thereby, the front wheel braking forces BF start to be increased, and the rear wheel braking forces BR start to be maintained. As a result, the front wheel speeds VF decrease after the front wheel speeds VF become higher than the regaining determination threshold Vg. On the other hand, the rear wheel speeds VR continue increasing and then, decrease with the vehicle body moving speed decreasing.

Then, at a point of time t83, the front wheel speeds VF reach the lower limit wheel speed Vref. Thus, at the point of time t83, the first decrease control and the second increase control start to be executed. Thereby, the front wheel braking forces BF start to be decreased, and the rear wheel braking forces BR start to be increased. As a result, the front wheel speeds VF increase after the front wheel speeds VF become lower than the lower limit wheel speed Vref. On the other hand, the rear wheel speeds VR continue decreasing.

Then, at a point of time t84, the rear wheel speeds VR reach the lower limit wheel speed Vref. Thus, at the point of time t84, the first increase control and the second decrease control start to be executed. Thereby, the front wheel braking forces BF start to be increased, and the rear wheel braking forces BR start to be decreased. As a result, the front wheel speeds VF start to decrease. On the other hand, the rear wheel speeds VR increase after the rear wheel speeds VR become lower than the lower limit wheel speed Vref.

Then, (i) the first increase control and the second decrease control and (ii) the first decrease control and the second increase control are repeatedly and alternately executed until the predetermined stop condition becomes satisfied.

<Effects>

As described above, the short braking distance of the vehicle can be achieved by preventing all of the wheel speeds from simultaneously decreasing to the larger extent than the decrease of the actual vehicle body moving speed. In addition, the process to separately increase and decrease the braking forces applied to the road wheels makes all of the wheel speeds simultaneously decrease to the larger extent than the decrease of the actual vehicle body moving speed.

With the vehicle control apparatus 10 according to the first modified example, the front wheel braking forces BF are increased together and decreased together while the wheel speed change control is executed. Therefore, the front wheel braking forces BF are not separately increased and decreased. Similarly, the rear wheel braking forces BR are increased together and decreased together while the wheel speed change control is executed. Therefore, the rear wheel braking forces BR are not separately increased and decreased. Thus, all of the wheel speeds V can be prevented from simultaneously decreasing to the larger extent than the decrease of the actual vehicle body moving speed V100.

In addition, while the first increase control is executed, the second decrease control is also executed. Therefore, while the front wheel speeds VF decrease, the rear wheel speeds VR increase. Further, while the second increase control is executed, the first decrease control is also executed. Therefore, while the rear wheel speeds VR decrease, the front wheel speeds VF increase. Thus, all of the wheel speeds V can be prevented from simultaneously decreasing to the larger extent than the decrease of the actual vehicle body moving speed V100.

<Concrete Operations>

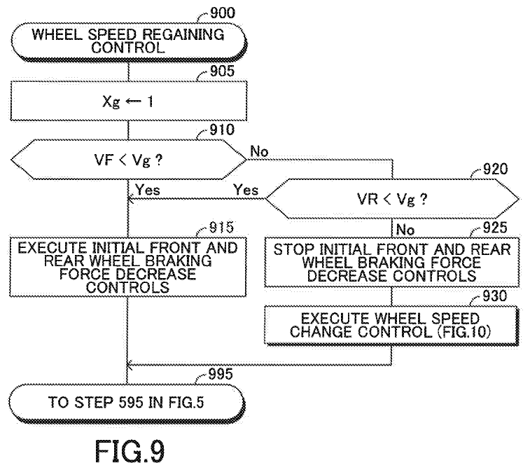

The CPU of the ECU 90 of the vehicle control apparatus 10 according to the first modified example is configured or programmed to execute the routine shown in FIG. 5 each time the predetermined time Tc elapses. In this case, the CPU executes a routine shown in FIG. 9 at the step 535 in FIG. 5 in place of executing the routine shown in FIG. 6.

Therefore, when the CPU proceeds with the process to the step 535 in FIG. 5, the CPU starts a process from a step 900 in FIG. 9 and proceeds with the process to a step 905 to set the value of the wheel speed regaining control flag Xg to “1.” Next, the CPU proceeds with the process to a step 910 to determine whether both of the front wheel speeds VF are lower than the regaining determination threshold Vg. When the CPU determines “Yes” at the step 910, the CPU proceeds with the process to a step 915.

On the other hand, when the CPU determines “No” at the step 910, the CPU proceeds with the process to a step 920 to determine whether both of the rear wheel speeds VR are lower than the regaining determination threshold Vg. When the CPU determines “Yes” at the step 920, the CPU proceeds with the process to the step 915.

When the CPU proceeds with the process to the step 915, the CPU executes the initial front and rear wheel braking force decrease controls. Then, the CPU proceeds with the process to the step 595 in FIG. 5 via a step 995 to terminate executing this routine once.

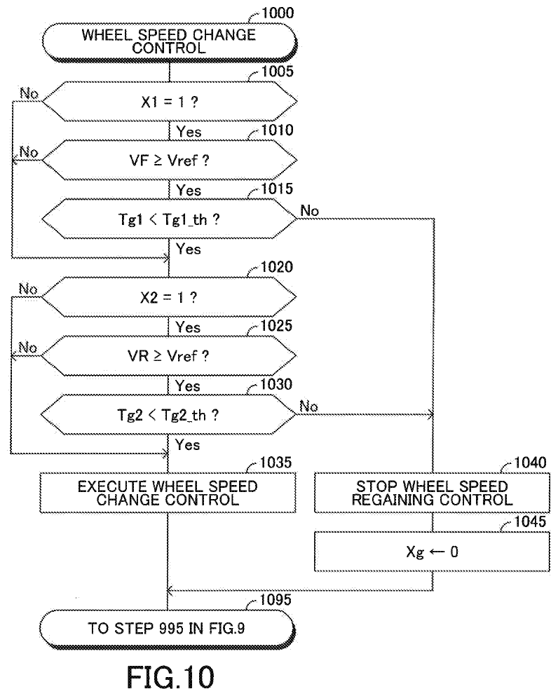

On the other hand, when the CPU determines “No” at the step 920, the CPU proceeds with the process to a step 925 to stop executing the initial front and rear wheel braking force decrease controls. Next, the CPU proceeds with the process to a step 930 to execute the wheel speed change control. The wheel speed change control is realized by executing a routine shown in FIG. 10.

Therefore, when the CPU proceeds with the process to the step 930, the CPU starts a process from a step 1000 in FIG. 10 and proceeds with the process to a step 1005 to determine whether a value of a first increase control flag X1 is “1.” The value of the first increase control flag X1 is set to “1” when the first increase control starts to be executed. On the other hand, the value of the first increase control flag X1 is set to “0” when the first increase control stops being executed.

When the CPU determines “Yes” at the step 1005, the CPU proceeds with the process to a step 1010 to determine whether both of the front wheel speeds VF are higher than or equal to the lower limit wheel speed Vref.

When the CPU determines “Yes” at the step 1010, the CPU proceeds with the process to a step 1015 to determine whether the front wheel speed regaining amount of time Tg1 is shorter than the predetermined amount of time Tg1_th.

When the CPU determines “Yes” at the step 1015, the CPU proceeds with the process to a step 1020. In addition, when the CPU determines “No” at the step 1005 or 1010, the CPU proceeds with the process to the step 1020.

When the CPU proceeds with the process to the step 1020, the CPU determines whether a value of a second increase control flag X2 is “1.” The value of the second increase control flag X2 is set to “1” when the second increase control starts to be executed. On the other hand, the value of the second increase control flag X2 is set to “0” when the second increase control stops being executed.

When the CPU determines “Yes” at the step 1020, the CPU proceeds with the process to a step 1025 to determine whether both of the rear wheel speeds VR are higher than or equal to the lower limit wheel speed Vref.

When the CPU determines “Yes” at the step 1025, the CPU proceeds with the process to a step 1030 to determine whether the rear wheel speed regaining amount of time Tg2 is shorter than the predetermined amount of time Tg2_th.

When the CPU determines “Yes” at the step 1030, the CPU proceeds with the process to a step 1035. In addition, when the CPU determines “No” at the step 1020 or 1025, the CPU proceeds with the process to the step 1035.

When the CPU proceeds with the process to the step 1035, the CPU executes the wheel speed change control. Next, the CPU proceeds with the process to the step 595 in FIG. 5 via a step 1095 and the step 995 in FIG. 9 to terminate executing this routine once.

Further, when the CPU determines “No” at the step 1015 or 1030, the CPU proceeds with the process to a step 1040 to stop executing the wheel speed regaining control. Thereby, the wheel speed change control stops being executed. Next, the CPU proceeds with the process to a step 1045 to set the value of the wheel speed regaining control flag Xg to “0.” Next, the CPU proceeds with the process to the step 595 in FIG. 5 via the step 1095 and the step 995 in FIG. 9 to terminate executing this routine once.

The concrete operations of the vehicle control apparatus 10 according to the first modified example have been described. When the vehicle control apparatus 10 according to the first modified example executes the routines shown in FIGS. 5, 9 and 10, the front wheel braking forces BF are increased together and decreased together while the wheel speed change control is executed. Therefore, the front wheel braking forces BF are not separately increased and decreased. In addition, the rear wheel braking forces BR are increased together and decreased together while the wheel speed change control is executed. Therefore, the rear wheel braking forces BR are not separately increased and decreased. Thus, all of the wheel speeds V can be prevented from simultaneously decreasing to the larger extent than the decrease of the actual vehicle body moving speed V100.

In addition, the first increase control and the second decrease control are simultaneously executed, and the second increase control and the first decrease control are simultaneously executed. Therefore, the rear wheel speeds VR increase while the front wheel speeds VF decrease, and the front wheel speeds VF increase while the rear wheel speeds VR decrease. Thus, all of the wheel speeds V can be prevented from simultaneously decreasing to the larger extent than the decrease of the actual vehicle body moving speed V100.

<Second Modified Example>

Next, the vehicle control apparatus 10 according to a second modified example of the embodiment of the present disclosure will be described. The vehicle control apparatus 10 according to the second modified example executes the wheel speed regaining control as described below. Hereinafter, the vehicle control apparatus 10 according to the second modified example will be simply referred to as “the vehicle control apparatus 10.”

<Summary of Operations>

The vehicle control apparatus 10 executes the ordinary braking control described above when the vehicle control apparatus 10 determines that the driver operates the brake pedal 31. When any one of the wheel speeds V becomes lower than the lower limit wheel speed Vref while the vehicle control apparatus 10 executes the ordinary braking control, the vehicle control apparatus 10 stops executing the ordinary braking control and starts to execute the wheel speed regaining control. The wheel speed regaining control according to the second modified example includes a wheel speed change control described below in addition to the initial front and rear wheel braking force decrease controls described above.

<Wheel Speed Change Control>

The wheel speed change control according to the second modified example includes (i) the first increase control, (ii) the first decrease control, (iii) the second increase control, and (iv) the second decrease control described above. When the vehicle control apparatus 10 starts to execute the wheel speed regaining control, the vehicle control apparatus 10 starts to execute the initial front and rear wheel braking force decrease controls. Thereby, the front wheel speeds VF and the rear wheel speeds VR increase together.

When any one of the front wheel speeds VF becomes equal to or higher than Vg while the vehicle control apparatus 10 executes the initial front wheel braking force decrease control, the vehicle control apparatus 10 stops executing the initial front wheel braking force decrease control and starts to execute the first increase control. Thereby, the front wheel speeds VF decrease together. Further, when any one of the front wheel speeds VF becomes lower than Vref while the vehicle control apparatus 10 executes the first increase control, the vehicle control apparatus 10 stops executing the first increase control and starts to execute the first decrease control. Thereby, the front wheel speeds VF increase together. Further, when any one of the front wheel speeds VF becomes equal to or higher than Vg while the vehicle control apparatus 10 executes the first decrease control, the vehicle control apparatus 10 stops executing the first decrease control and starts to execute the first increase control.

The vehicle control apparatus 10 repeatedly and alternately executes the first increase control and the first decrease control as far as the predetermined stop condition is not satisfied. The predetermined stop condition here becomes satisfied when a state that all of the wheel speeds V are higher than or equal to the lower limit wheel speed Vref continues for the predetermined amount of time Tg0_th while the vehicle speed change control is executed.

It should be noted that the vehicle control apparatus 10 may be configured to stop executing the first decrease control and start to execute the first increase control when (i) both of the front wheel speeds VF become equal to or higher than the regaining determination threshold Vg while the first decrease control is executed or (ii) the average of the front wheel speeds VF becomes equal to or higher than the regaining determination threshold Vg while the first decrease control is executed.

On the other hand, when any one of the rear wheel speeds VR becomes equal to or higher than Vg while the vehicle control apparatus 10 executes the initial rear wheel braking force decrease control, the vehicle control apparatus 10 stops executing the initial rear wheel braking force decrease control and starts to execute the second increase control. Thereby, the rear wheel speeds VR decrease together. Further, when any one of the rear wheel speeds VR becomes lower than Vref while the vehicle control apparatus 10 executes the second increase control, the vehicle control apparatus 10 stops executing the second increase control and starts to execute the second decrease control. Thereby, the rear wheel speeds VR increase together. Further, when any one of the rear wheel speeds VR becomes equal to or higher than Vg while the vehicle control apparatus 10 executes the second decrease control, the vehicle control apparatus 10 stops executing the second decrease control and starts to execute the second increase control.

The vehicle control apparatus 10 repeatedly and alternately executes the second increase control and the second decrease control as far as the predetermined stop condition is not satisfied. The predetermined stop condition here becomes satisfied when the state that all of the wheel speeds V are higher than or equal to the lower limit wheel speed Vref continues for the predetermined amount of time Tg0_th while the vehicle speed change control is executed.

It should be noted that the vehicle control apparatus 10 may be configured to stop executing the second decrease control and start to execute the second increase control when (i) both of the rear wheel speeds VR become equal to or higher than the regaining determination threshold Vg while the second decrease control is executed or (ii) the average of the rear wheel speeds VR becomes equal to or higher than the regaining determination threshold Vg while the second decrease control is executed.

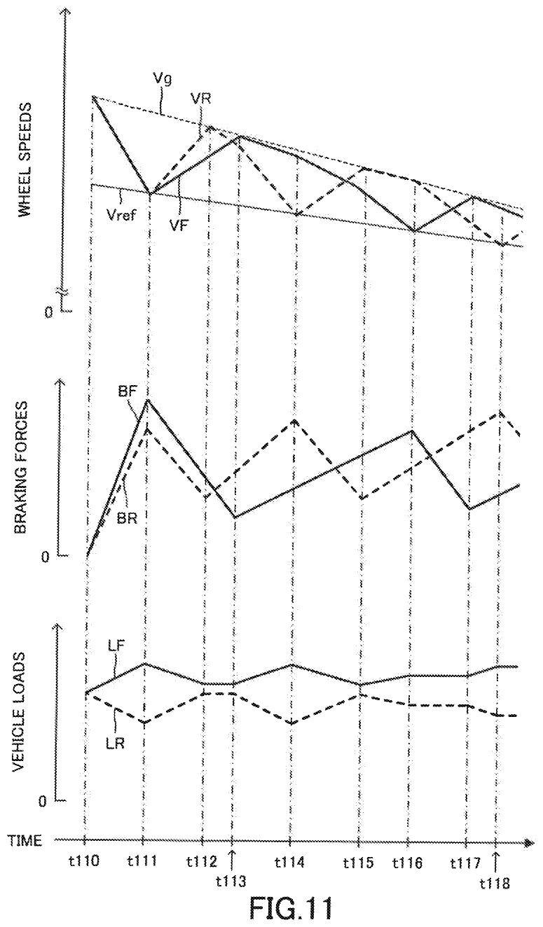

When the wheel speed regaining control according to the second modified example is executed, the braking forces B are controlled, and the wheel speeds V change, for example, as shown in FIG. 11. In FIG. 11, the front wheel braking forces BF and the front wheel speeds VF are shown by solid lines, and the rear wheel braking forces BR and the rear wheel speeds VR are shown by chain lines.

In an example shown in FIG. 11, the ordinary braking control starts to be executed at a point of time t110. Thereby, the front wheel braking forces BF and the rear wheel braking forces BR start to be increased together. As a result, the front wheel speeds VF and the rear wheel speeds VR start to decrease together. At this time, a vehicle load transfers to a front portion of the vehicle 100. As a result, a load LF of the front portion of the vehicle 100 increases, and a load LR of a rear portion of the vehicle 100 decreases.

Then, at a point of time t111, the front wheel speeds VF and the rear wheel speeds VR reach the lower limit wheel speed Vref. Thus, at the point of time t111, the initial front and rear wheel braking force decrease controls start to be executed. Thereby, the front wheel braking forces BF and the rear wheel braking forces BR start to be decreased together. As a result, the front wheel speeds VF and the rear wheel speeds VR start to increase together. At this time, the vehicle load transfers to the rear portion of the vehicle 100. As a result, the load LF of the front portion of the vehicle 100 decreases, and the load LR of the rear portion of the vehicle 100 increases. Thus, the rear wheel speeds VR increase faster than the front wheel speeds VF. Therefore, the rear wheel speeds VR are more likely to reach the regaining determination threshold Vg faster than the front wheel speeds VF. Thus, the front wheel speeds VF and the rear wheel speeds VR may reach the regaining determination threshold Vg at different timings.

Then, at a point of time t112, the rear wheel speeds VR reach the regaining determination threshold Vg. Thus, at the point of time t112, the wheel speed regaining control to the rear wheel braking forces BR starts to be executed. When the wheel speed regaining control to the rear wheel braking forces BR starts to be executed, the second increase control starts to be executed. Thereby, the rear wheel braking forces BR start to be increased. As a result, the rear wheel speeds VR start to decrease together. At the point of time t112, the front wheel speeds VF do not reach the regaining determination threshold Vg. Therefore, the initial front wheel braking force decrease control continues being executed. Thus, the front wheels VF continues increasing together. At this time, an amount of transfer of the vehicle load is small.

Then, at a point of time t113, the front wheel speeds VF reach the regaining determination threshold Vg. Thus, at the point of time t113, the first increase control starts to be executed. Thereby, the front wheel braking forces BF start to be increased. As a result, the front wheel speeds VF start to decrease together. At the point of time t113, the rear wheel speeds VR are higher than or equal to the lower limit wheel speed Vref. Therefore, the second increase control continues being executed. Thus, the rear wheel speeds VR continues decreasing together. At this time, the vehicle load transfers to the front portion of the vehicle 100. As a result, the load LF of the front portion of the vehicle 100 increases, and the load LR of the rear portion of the vehicle 100 decreases. Thus, the rear wheel speeds VR decrease faster than the front wheel speeds VF. Therefore, the rear wheel speeds VR are more likely to reach the lower limit wheel speed Vref faster than the front wheel speeds VF. Thus, the front wheel speeds VF and the rear wheel speeds VR may reach the lower limit wheel speed Vref at different timings.

Then, at a point of time t114, the rear wheel speeds VR reach the lower limit wheel speed Vref. Thus, at the point of time t114, the second decrease control starts to be executed. Thereby, the rear wheel braking forces BR start to be decreased. As a result, the rear wheel speeds VR start to increase together. At the point of time t114, the front wheel speeds VF are higher than or equal to the lower limit wheel speed Vref. Therefore, the first increase control continues being executed. Thus, the front wheels VF continues decreasing together. At this time, the amount of transfer of the vehicle load is small.

Then, the vehicle speed change control continues being executed as far as the predetermined stop condition is not satisfied.

<Effects>

Unlike the vehicle control apparatus 10 according to the embodiment and the first modified example, the vehicle control apparatus 10 according to the second modified example does not positively execute a control to increase the front wheel braking forces BF as well as decrease the rear wheel braking forces BR nor a control to increase the rear wheel braking forces BR as well as decrease the front wheel braking forces BF.

The vehicle control apparatus 10 according to the second modified example alternately increases and decreases the front wheel braking forces BF together and alternately increases and decreases the rear wheel braking forces BR together. Therefore, all of the wheel speeds V can be prevented from simultaneously decreasing to the larger extent than the decrease of the actual vehicle body moving speed V100.

In particular, as described above, when the front wheel braking forces BF are increased together and decreased together, and the rear wheel braking forces BR are increased together and decreased together, the vehicle load transfers between the front and rear portions of the vehicle 100. Thus, the front wheel speeds VF and the rear wheel speeds VR may reach the lower limit wheel speed Vref and the regaining determination threshold Vg at different timings. This means that all of the vehicle speeds V do not simultaneously decrease to the larger extent than the decrease of the actual vehicle body moving speed V100. Therefore, all of the wheel speeds V can be prevented from simultaneously decreasing to the larger extent than the decrease of the actual vehicle body moving speed V100.

What is claimed is:

1. A vehicle control apparatus applied to a vehicle including at least two first road wheels and at least one second road wheel,
the vehicle control apparatus comprising:
a braking apparatus which individually applies braking forces to the at least two first road wheels and the at least one second road wheel; and
an electronic control unit which controls (i) first braking forces corresponding to the braking forces applied to the at least two first road wheels from the braking apparatus and (ii) a second braking force corresponding to the braking force applied to the at least one second road wheel from the braking apparatus,
wherein the electronic control unit is configured to:
set a lower limit wheel speed, based on at least one of speeds of the at least two first road wheels and the at least one second road wheel, which produces a maximum friction coefficient between (i) each of the at least two first road wheels and the at least one second road wheel and (ii) a surface of a road which the at least two first road wheels and the at least one second road wheel contact;
execute a wheel speed change control to control the speeds of the at least two first road wheels and the at least one second road wheel to values equal to or larger than the lower limit wheel speed when (i) the electronic control unit applies the braking forces to the at least two first road wheels and the at least one second road wheel, and (ii) at least one of the speeds of the at least two first road wheels and the at least one second road wheel becomes lower than the lower limit wheel speed; and
execute a vehicle speed change control to execute (i) a first increase-decrease control which alternately executes a first increase control to increase the first braking forces together and a first decrease control to decrease the first braking forces together and (ii) a second increase-decrease control which increases and decreases the second braking force.

2. The vehicle control apparatus as set forth in claim 1, wherein:
the at least one second road wheel includes road wheels; and
the second increase-decrease control is a control to alternately executes a second increase control to increase the second braking forces together and a second decrease control to decrease the second braking forces together.

3. A vehicle control apparatus applied to a vehicle including at least two first road wheels and at least one second road wheel,
the vehicle control apparatus comprising:
a braking apparatus which individually applies braking forces to the at least two first road wheels and the at least one second road wheel; and
an electronic control unit which controls (i) first braking forces corresponding to the braking forces applied to the at least two first road wheels from the braking apparatus and (ii) a second braking force corresponding to the braking force applied to the at least one second road wheel from the braking apparatus,
wherein the electronic control unit is configured to:
set a lower limit wheel speed, based on at least one of speeds of the at least two first road wheels and the at least one second road wheel, which produces a maximum friction coefficient between (i) each of the at least two first road wheels and the at least one second road wheel and (ii) a surface of a road which the at least two first road wheels and the at least one second road wheel contact;
execute a wheel speed change control to control the speeds of the at least two first road wheels and the at least one second road wheel to values equal to or larger than the lower limit wheel speed when (i) the electronic control unit applies the braking forces to the at least two first road wheels and the at least one second road wheel, and (ii) at least one of the speeds of the at least two first road wheels and the at least one second road wheel becomes lower than the lower limit wheel speed; and
execute a vehicle speed change control to (i) decrease the second braking force during a first period while at least one of the first braking forces is increased and (ii) decrease at least one of the first braking forces during a second period while the second braking force is increased.

4. The vehicle control apparatus as set forth in claim 3, wherein:
the vehicle speed change control is a control to execute (i) a first increase-decrease control which alternately executes a first increase control to increase the at least one of the first braking forces and a first decrease control to decrease the at least one of the first braking forces and (ii) a second increase-decrease control which alternately executes a second increase control to increase the second braking force and a second decrease control to decrease the second braking force.

5. The vehicle control apparatus as set forth in claim 3, wherein:
the vehicle speed change control is a control to execute a first increase control to increase the at least one of the first braking forces, a first decrease control to decrease the at least one of the first braking forces, a second increase control to increase the second braking force, and a second decrease control to decrease the second braking force.

6. A vehicle control apparatus applied to a vehicle including at least one front road wheel and at least one rear road wheel,
the vehicle control apparatus comprising:
a braking apparatus which individually applies braking forces to the at least one front road wheel and the at least one rear road wheel; and
an electronic control unit which controls (i) a front road wheel braking force corresponding to the braking force applied to the at least one front road wheel from the braking apparatus and (ii) a rear road wheel braking force corresponding to the braking force applied to the at least one rear road wheel from the braking apparatus,
wherein the electronic control unit is configured to:
set a lower limit wheel speed, based on at least one of speeds of the at least one front road wheel and the at least one rear road wheel, which produces a maximum friction coefficient between (i) each of the at least one front road wheel and the at least one rear road wheel and (ii) a surface of a road which the at least one front road wheel and the at least one rear road wheel contact; and
execute a wheel speed change control to control the speeds of the at least one front road wheel and the at least one rear road wheel to values equal to or larger than the lower limit wheel speed when (i) the electronic control unit applies the braking forces to the at least one front road wheel and the at least one rear road wheel, and (ii) at least one of the speeds of the at least one front road wheel and the at least one rear road wheel becomes lower than the lower limit wheel speed, and
wherein the wheel speed change control is a control to:
execute a first decrease control to decrease the front road wheel braking force when (i) the braking forces are applied to the at least one front road wheel and the at least one rear road wheel, and (ii) the speed of the at least one front road wheel becomes lower than the lower limit wheel speed;
execute a first increase control to increase the front road wheel braking force when the speed of the at least one front road wheel becomes equal to or higher than a regaining determination threshold higher than the lower limit wheel speed while the first decrease control is executed;
execute a second decrease control to decrease the rear road wheel braking force when (i) the braking forces are applied to the at least one front road wheel and the at least one rear road wheel, and (ii) the speed of the at least one rear road wheel becomes lower than the lower limit wheel speed; and
execute a second increase control to increase the rear road wheel braking force when the speed of the at least one rear road wheel becomes equal to or higher than the regaining determination threshold while the second decrease control is executed.

7. The vehicle control apparatus as set forth in claim 1, wherein:
the vehicle includes a front left road wheel, a front right road wheel, a rear left road wheel, and a rear right road wheel;
the at least two first road wheels include the front left road wheel and the front right road wheel; and
the at least one second road wheel includes the rear left road wheel and the rear right road wheel.

8. The vehicle control apparatus as set forth in claim 1, wherein:
the vehicle includes a front left road wheel, a front right road wheel, a rear left road wheel, and a rear right road wheel;
the at least two first road wheels include the front left road wheel and the rear left road wheel; and
the at least one second road wheel includes the front right road wheel and the rear right road wheel.

9. The vehicle control apparatus as set forth in claim 1, wherein:
the electronic control unit is configured to stop executing the wheel speed change control when the speeds of the at least two first road wheels and the at least one second road wheel become equal to or higher than the lower limit wheel speed while the electronic control unit executes the wheel speed change control.

10. The vehicle control apparatus as set forth in claim 1, wherein:
the electronic control unit is configured to stop executing the wheel speed change control when the speeds of the at least two first road wheels and the at least one second road wheel continue being equal to or higher than the lower limit wheel speed for a predetermined amount of time while the electronic control unit executes the wheel speed change control.

11. The vehicle control apparatus as set forth in claim 1, wherein:
the electronic control unit is configured to:
stop executing the wheel speed change control when the speeds of the first road wheels become equal to or higher than a regaining determination threshold higher than the lower limit wheel speed while the electronic control unit executes the first decrease control; and
stop executing the wheel speed change control when the speed of the at least one second road wheel becomes equal to or higher than the regaining determination threshold while the electronic control unit increases the second braking force.

12. The vehicle control apparatus as set forth in claim 1, wherein:
the electronic control unit is configured to:
stop executing the wheel speed change control when the speeds of the at least two first road wheels continue being equal to or higher than a regaining determination threshold higher than the lower limit wheel speed for a predetermined first amount of time while the electronic control unit executes the first decrease control; and
stop executing the wheel speed change control when the speed of the at least one second road wheel continues being equal to or higher than the regaining determination threshold for a predetermined second amount of time while the electronic control unit increases the second braking force.

13. The vehicle control apparatus as set forth in claim 1, wherein:
the lower limit wheel speed is the at least one of the speeds of the at least two first road wheels and the at least one second road wheel, which (i) produces the maximum friction coefficient between each of the at least two first road wheels and the at least one second road wheel and the surface of the road and (ii) causes a friction coefficient between each of the at least two first road wheels and the at least one second road wheel and the surface of the road to be a lower limit value of an acceptable range.

14. The vehicle control apparatus as set forth in claim 1, wherein:
the electronic control unit is configured to set the lower limit wheel speed, based on a moving speed of a body of the vehicle acquired, based on at least one of the speeds of the at least two first road wheels and the at least one second road wheel.
